(19) United States
(12) Patent Application Publication
(10) Pub. No.: US 2026/0278340 A1
(43) Pub. Date: Sep. 17, 2026

(54) MULTI-MODAL NEURAL NETWORKS WITH DECODER-ONLY LANGUAGE MODELS

(71) Applicant: Google LLC, Mountain View, CA (US)

(72) Inventors: Weicheng Kuo, Berkeley, CA (US); Anthony Jacob Piergiovanni, Nazareth, PA (US); Dahun Kim, Sunnyvale, CA (US); Xiyang Luo, San Jose, CA (US); Benjamin James Caine, San Francisco, CA (US); Abhijit Ogale, Sunnyvale, CA (US); Yingwei Cui, Los Altos, CA (US); Anelia Angelova, Sunnyvale, CA (US)

(21) Appl. No.: 19/168,538

(22) PCT Filed: Mar. 25, 2024
(86) PCT No.: PCT/US2024/021330

§ 371 Date: Sep. 24, 2025

Related U.S. Application Data
(60) Provisional application No. 63/454,603, filed on Mar. 24, 2023.

(51) Int. Cl. G06N 3/0455; G06N 3/0475; G06V 10/82

(52) U.S. Cl. CPC G06N 3/0455; G06N 3/0475; G06V 10/82

(57) ABSTRACT

Methods, systems, and apparatus, including computer programs encoded on computer storage media, for training a multi-modal neural network using contrastive and image captioning losses.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that processes multi-modal inputs that include both a visual input, i.e., an image or multiple video frames from a video, and text using a multi-modal neural network.

As will be described below, the system can pre-train the multi-modal neural network jointly using both a contrastive learning loss and a captioning loss.

Particular embodiments of the subject matter described in this specification can be implemented so as to realize one or more of the following advantages.

This specification describes a multi-modal neural network that has an architecture that allows the neural network to be pre-trained jointly with a contrastive loss and a captioning loss.

Unlike other approaches, the neural network uses a shared, decoder-only language model neural network to compute both the text embedding for the contrastive loss and the text caption data for the captioning loss.

In particular, previous approaches used separate components to compute the text-based inputs to these two losses under the assumption that the conflicting nature of the two tasks, i.e., the fact that contrastive learning uses unconditional sequence-level text representations whereas captioning optimizes the likelihood of each token in a text sequence conditioned on the previous tokens and a corresponding image, would make using a unified representation problematic or harm overall performance.

The described techniques on the other hand, use a unified representation generated from a decoder-only language model and demonstrate that joint training of these diverse-objective tasks is possible. As a result, these techniques maximize weight-sharing of the language model neural network, i.e., by sharing more of the parameters of the model between the contrastive and captioning losses, while leading to state-of-the-art performance on a variety of downstream multi-modal tasks. This leads to a more compact model with fewer parameters and as such has lower memory and storage requirements. The model may be deployed on devices with limited computational resources such as mobile devices or edge devices.

Furthermore, using the same core architecture enables very easy extensions to open-vocabulary object detection and video-text tasks, which, unlike prior works, is done with minimal modifications. For example, the described techniques can be used to achieve state-of-the-art results on a variety of multi-modal tasks, e.g., on image-text and text-image retrieval, video question answering and open-vocabulary detection tasks.

Moreover, many existing approaches use separate visual input encoders or separate passes through a single visual encoder for computing contrastive and image captioning losses. The described approach uses only a single pass through a single visual encoder for computing both losses. Because the visual encoder is generally the most computationally expensive component of the system, using only a single pass through the visual encoder to compute both the contrastive and captioning losses significantly reduces the latency, the FLOPs and computational resource consumption of the training process.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network system.

FIG. 1B shows an example of the training of the multi-modal neural network.

FIG. 2 is a flow diagram of an example process for training the multi-modal neural network.

FIG. 3 is a flow diagram of an example process for performing a training step during the training of the multi-modal neural network.

FIG. 4 shows an example of performing a training step.

Like reference numbers and designations in the various drawings indicate like elements.

### DETAILED DESCRIPTION

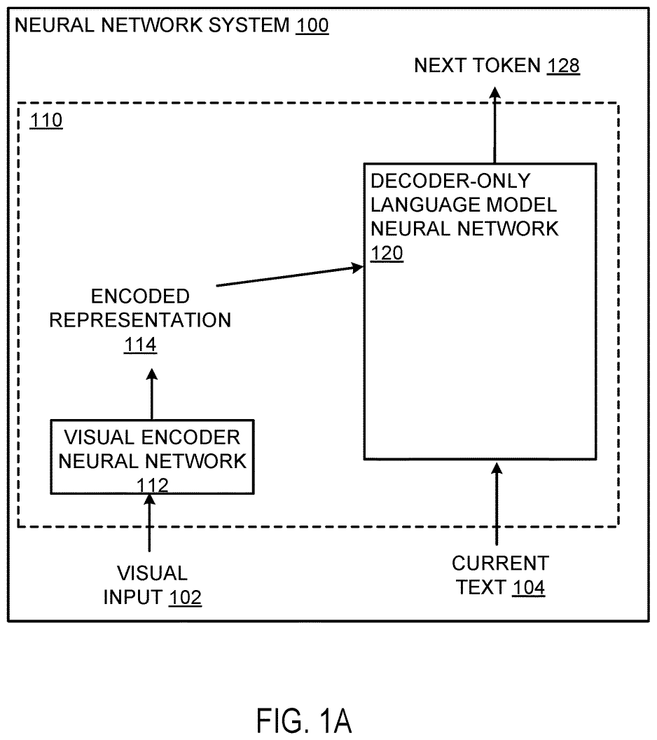

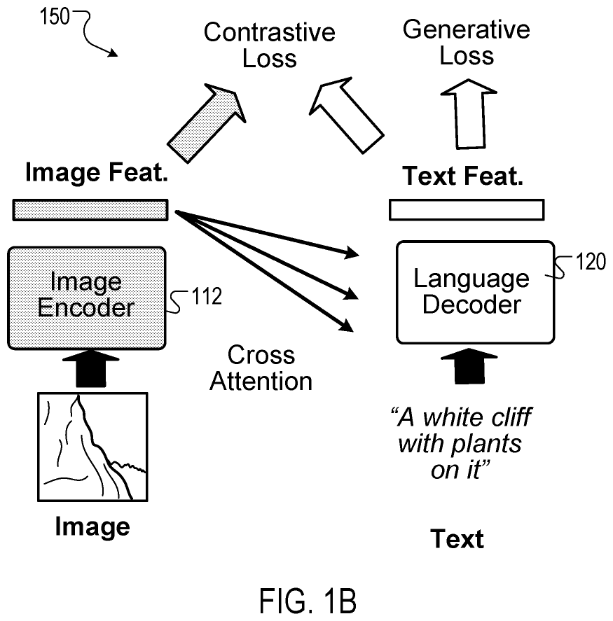

FIG. 1A shows an example neural network system 100. The neural network system 100 is an example of a system implemented as computer programs on one or more computers in one or more locations, in which the systems, components, and techniques described below can be implemented.

The system 100 is a system that processes multi-modal inputs that include both a visual input 102, i.e., an image or multiple video frames from a video, and text using a multi-modal neural network 110. That is, the system 100 process a multi-modal input that includes the intensity values of the pixels of the image or of the multiple video frames and a corresponding text sequence.

The multi-modal neural network 110 includes (i) a visual encoder neural network 112 that is configured to process a visual input 102 that includes one or more images to generate an encoded representation 114 of the visual input 102 and (ii) a decoder-only language model neural network 120.

Generally, the system 100 can pre-train the multi-modal neural network 110 on both a contrastive loss and a captioning loss.

The contrastive loss can depend on the encoded representations generated by the visual encoder, e.g., on embeddings generated from the encoded representations, and text embeddings generated from representations generated by the language model neural network while the captioning loss can depend on the encoded representations generated by the visual encoder and scores generated by the language model neural network.

After the multi-modal neural network 110 has been pre-trained, the multi-modal neural network 110, visual encoder 112, the language model 120, or some combination of the above can be used for a downstream task.

In some implementations, the downstream task can be performed in a zero shot manner, i.e., without further training of any of the components of the multi-modal neural network 110.

In some other implementations, the downstream task can be performed after fine-tuning, i.e., further training, one or more of the components of the multi-modal neural network 110 on labeled training data for the downstream task.

As one example, the system 100 can fine-tune the multi-modal neural network 110 on labeled training data without modifying the architecture of the network 110.

As another example, the system can hold the visual encoder 112 and any parts of the language model neural network that are used for the downstream task fixed while learning one or more additional layers that (i) process encoded representations generated by the visual encoder 112 to generate the output for the downstream task, (ii) generate an input to the visual encoder, or (iii) both.

In some examples, the downstream task is a visual classification task that requires classifying a visual input, e.g., a video or an image, into one of a set of categories that each correspond to a different object type.

In some other examples, the downstream task is visual action recognition task that requires classifying a video input into one of a set of action categories.

In some examples, the downstream task is a cross-modal retrieval task that requires (i) retrieving one or more most similar text sequences to a visual input or (ii) retrieving one or more most similar visual inputs to a text sequence.

In some examples, the downstream task is a multimodal understanding task. For example, the task can be a visual question answering task (VQA) that requires generating an answer to a question that is posed about a visual input.

In some examples, the downstream task is an image captioning task that requires generating a text caption for a visual input.

In some examples, the downstream task is an open vocabulary object detection task that requires detecting objects in an input image.

Generally, the system 100 can perform the training for the downstream task in any appropriate manner, i.e., using any appropriate supervised learning loss function that is appropriate for the downstream task.

Generally, the language model neural network 120 is configured to process a current text sequence 104 to generate an output defining a new token 128 to be appended to the current text sequence 104.

The output defining a new token 128 to be appended to the current text sequence 104 generally includes a respective score for each token in a vocabulary of tokens. The vocabulary of tokens can include any of: characters, subwords, words, punctuation marks, sign tokens (e.g., the #, $, and other signs), mathematical symbols, and so on. The vocabulary of tokens can also include one or more special tokens that are appended to input text sequences that processed by the neural network, e.g., a start of sequence token, an end of sequence token, a designated “class” token, and so on.

During training, the language model neural network 120 can generate a respective output for each of multiple tokens in an input sequence in a single forward pass, i.e., in parallel, by processing a single “current sequence” 104 that represents the entire input text sequence.

After training, the language model neural network 120 can be used to auto-regressively generate a text sequence by, at each time step, processing the current text sequence 104 as of the time step and then updating the current text sequence 104 by selecting a token from the vocabulary using the output for the current text sequence and then appending the selected token to the end of the current text sequence 104.

The visual encoder neural network 112 is a neural network that has parameters (“visual encoder neural network parameters” or “visual encoder parameters”) and receives a visual input 102, e.g., an input image or a video, and processes the visual input 102 in accordance with the parameters to generate an encoded representation 114 of the visual input 102.

Generally, the encoded representation 114 includes a respective embedding (also referred to as “updated token”) for each of multiple patches in the visual input 102, e.g., for each of multiple spatial patches (regions) of each of the images of the visual input 102 or, in some cases where the visual input 102 includes multiple images, each of multiple spatio-temporal patches (regions) of the visual input 102.

An “embedding” as used in this specification is a vector of numeric values, e.g., floating point values or other values, having a pre-determined dimensionality. The space of possible vectors having the pre-determined dimensionality is referred to as the “embedding space.”

The visual encoder neural network 112 can have any appropriate architecture that allows the neural network 112 to map an input visual input 102 to an encoded representation 114. For example, the visual encoder neural network 112 can be a convolutional neural network. As another example, the visual encoder neural network 112 can be a vision Transformer neural network that has one or more self-attention layers. As yet another example, the visual encoder neural network 112 can be a neural network that has a mix of both convolutional and self-attention layers.

When the encoder neural network 112 is a vision Transformer or other neural network that generates an initial embedding of each patch of the visual input 102 and in updates the initial embeddings to generate the encoded representation 114, the encoder neural network 112 can use cropped positional embeddings during training to improve the generalization of the neural network to downstream tasks after training.

Cropped positional embeddings cause the model to view an input image as a “crop” from a larger image. In particular, cropped positional embeddings of the patches of a given input image are generated by generating a random crop of a larger image, with the crop having the same size as the given input image. The cropped positional embeddings of the patches of the given input image are then generated by assigning, as the cropped positional embeddings of the patches of the input image, the positional embeddings of the corresponding patches from the crop of the larger image.

Cropped positional embeddings are described in more detail in Kim, et al, Region-Aware Pretraining for Open-Vocabulary Object Detection with Vision Transformers, available at arXiv:2305.07011.

The language model neural network 120 can have any appropriate architecture that allows the language model neural network 120 to map the tokens in the text sequence 104 to an output defining the next token 128.

In a particular example, the language model neural network 120 can have an attention-based architecture, e.g., the architecture of a decoder-only Transformer neural network.

In this example, the language model neural network 120 can include a sequence of layers that includes one or more self-attention layers, where each self-attention layer is configured to receive as input a respective current representation of each of the text tokens in the current text sequence and to process the respective current representations to generate as output a respective updated representation of each of the text tokens in the current text sequence by applying self-attention mechanism over the respective current representations.

A self-attention mechanism over the respective current representations refers to an attention mechanism that computes queries, keys, and values from the respective current representations.

After training, each self-attention attention layer can apply a causally masked self-attention mechanism over the respective current representations to generate the respective updated representations.

A causally masked self-attention mechanism over the respective current representations refers to an attention mechanism in which any given position in the current text sequence does not attend over, i.e., does not have a non-zero attention weight for, any positions after the given position in the current text sequence.

This is in contrast to a self-attention mechanism with a bi-directional mask, in which any given position in the current text sequence attends over, i.e., has a non-zero attention weight for, all positions in the current text sequence, irrespective of whether the positions are after the given position in the current text sequence or not.

Each self-attention layer can optionally apply other operations to the representations as part of updating the representations, e.g., by making use of a position-wise feed-forward neural network, by applying layer normalization, by making use of residual connections, and so on.

Optionally, during training, the system 100 can switch between applying the causal masking and not applying the causal masking during the processing of different inputs to the neural network 120.

In this example, the respective current representations that are received as input by the first self-attention layer in the sequence of layers are respective embeddings of each of the text tokens in the current text sequence, e.g., as generated by an embedding layer of the language model neural network 120 and the respective current representations that are received as input by each subsequent layer, i.e., each layer after the first layer in the sequence, are respective updated representations of the text tokens in the current text sequence that are generated as output by a preceding layer in the sequence of layers.

Additionally, the neural network 120 includes, as part of the sequence of layers, one or more cross-attention layers. Each cross-attention layer processes the respective current representations to generate as output a respective updated representation of each of the text tokens in the current text sequence by applying a cross-attention mechanism between an input derived from (generated from) the encoded representation of the visual input and the respective current representations of the text tokens in the current text sequence received as input by the cross-attention layer.

“Cross-attention” between the input derived from the encoded representation of the visual input and the respective current representations of the text tokens in the current text sequence received as input by the cross-attention layer refers to an attention mechanism that uses queries derived from the respective current representations of the text tokens in the current text sequence and keys and values derived from the input generated from the encoded representation of the visual input.

Specific examples of self-attention, cross-attention, and causally masked self-attention mechanisms that can be employed by the system are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020, Hua, et al, Transformer Quality in Linear Time, arXiv preprint arXiv:2202.10447, 2022.

In some implementations, the input that is derived from the encoded representations (also referred to as a captioning representation below) are the embeddings in the encoded representation 114.

In some other implementations, the neural network 110 applies one or more transformations to the encoded representation 114 to generate the input that is provided to the cross-attention layers.

For example, the neural network 110 can apply a linear layer or other learned transformation to project the encoded representation 114 to have the same dimensionality as the representations that are generated by the language model neural network 120.

Thus, the updated representations generated by a given cross-attention layer are multi-modal representations that depend on the visual input and on the text tokens in the current text sequence. Each of these cross-attention layers can optionally apply other operations to the representations as part of updating the representations, e.g., by making use of a position-wise feed-forward neural network, by applying layer normalization, by making use of residual connections, and so on.

As one example, the sequence of attention layers can alternate between self-attention layers and cross-attention layers. As another example, the sequence of attention layers can include a cross-attention layer after every two, three, or four self-attention layers.

Thus, due to the presence of the cross-attention layers, the representations generated by the last attention layer in the sequence are multi-modal representations, as described above.

To generate the score distribution, the neural network 120 can also include an output layer block.

The output layer block is a set of one or more neural network layers, e.g., one or more fully-connected layers followed by a softmax layer, that is configured to receive one or more of the respective updated representations of the text tokens in the current text sequence that are generated as output by the last subsequent attention layer in the sequence of subsequent attention layers and to process the one or more respective updated representations to generate the output defining the new token to be appended to the current text sequence, i.e., to generate the score distribution over the tokens in the vocabulary.

As a particular example, the output layer block can include a single fully-connected layer (“vocabulary embedding layer”), optionally followed by a softmax, that maps the respective updated representations to the score distributions.

For example, during training, when the current output sequence is the entire training sequence, the output layer block can generate the respective score distributions for each of the text tokens in parallel by, for each text token, processing the updated representation of the token that immediately precedes the text token in the training sequence to generate the score distribution for the text token. In this example, the system can augment the training sequence with a designated start of sequence of token before processing the training sequence using the language model neural network.

After training, when the system 100 is operating auto-regressively, the output layer block can generate a single score distribution for current output sequence by processing the updated representation for the last token in the current output sequence. The system 100 can then select the next token to be added to the current output sequence using the score distribution generated by the output layer block. For example, the system 100 can select the token with the highest score in the score distribution or can sample a token from the score distribution.

As described, the system 100 or another training system can pre-train the multi-modal neural network 110 on both a contrastive loss and a captioning loss.

FIG. 1B shows an example 150 of the training of the multi-modal neural network 110.

As shown above, during training, the system receives a training pair that includes an image and a text sequence (“a white cliff with plants on it”).

The system processes the image using the visual encoder neural network 112 to generate image features of the image.

The system also processes the text sequence using the decoder-only language model neural network 120 to generate text features of the image.

The system can then use the image features and the text features to compute the contrastive loss while using the text features to generate the scores that are used to compute the contrastive loss, as will be described in more detail below.

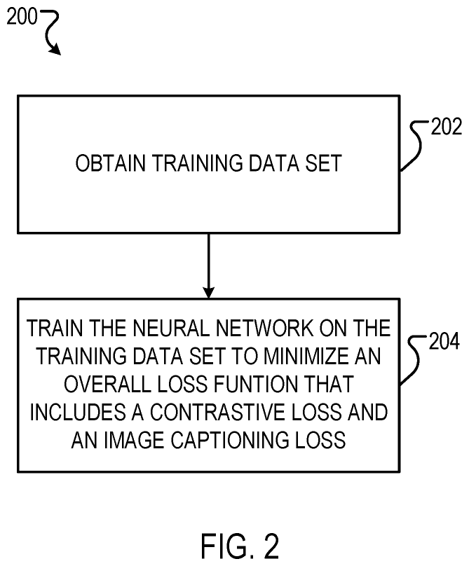

FIG. 2 is a flow diagram of an example process 200 for training the multi-modal neural network. For convenience, the process 200 will be described as being performed by a system of one or more computers located in one or more locations. For example, a neural network system, e.g., the neural network system 100 of FIG. 1, appropriately programmed, can perform the process 200.

The system obtains a training data set that includes a plurality of image-text sequence pairs (step 202).

That is, each pair in the training data set includes a visual input and an input text sequence.

In particular, the input text sequence has been determined by the system or an external source to describe the contents of the visual input or otherwise be relevant to the visual input. In other words, the visual input and the input text sequence have been determined to be semantically similar.

For example, within a given training pair, the text sequence can be a text annotation of the visual input from a set of manually or automatically generated image annotations or can be alt text associated with the visual input in a set of alt-text data. Alt text is text that is displayed in place of an image on a web page, e.g., if the image cannot be rendered properly or otherwise fails to load. For example, the system can obtain the alt-text data from data maintained by an Internet search engine or other software that automatically crawls web pages on the Internet.

The system trains the neural network on the training data set to minimize an overall loss function (step 204).

Generally, the overall loss function includes (i) a contrastive loss that measures similarities between image embeddings generated from encoded representations generated by the visual encoder neural network and text embeddings generated from outputs of the language model neural network and (ii) an image captioning loss that measures a quality of text captions generated by the language model neural network given encoded representations generated by the visual encoder neural network.

For example, the measure of quality may be based upon a ground-truth or target text caption that the language model neural network is expected to output. More specifically, the measure of quality can be based on scores that are assigned to the tokens in the target text caption by the language model neural network.

In particular, to train the neural network, the system can repeatedly perform iterations of a training process on different batches of training pairs sampled form the training data set to update the parameters of the visual encoder neural network, the language model neural network, or both.

That is, at each iteration of the training process, the system can obtain a batch of training pairs, e.g., by sampling the batch from the larger set of training data, and use the batch of one or more training pairs to update the parameters of the visual encoder neural network and the language model neural network.

The system can continue performing iterations of the training process until termination criteria for the training of the neural network have been satisfied, e.g., until the parameters have converged, until a threshold amount of wall clock time has elapsed, or until a threshold number of iterations of the process have been performed.

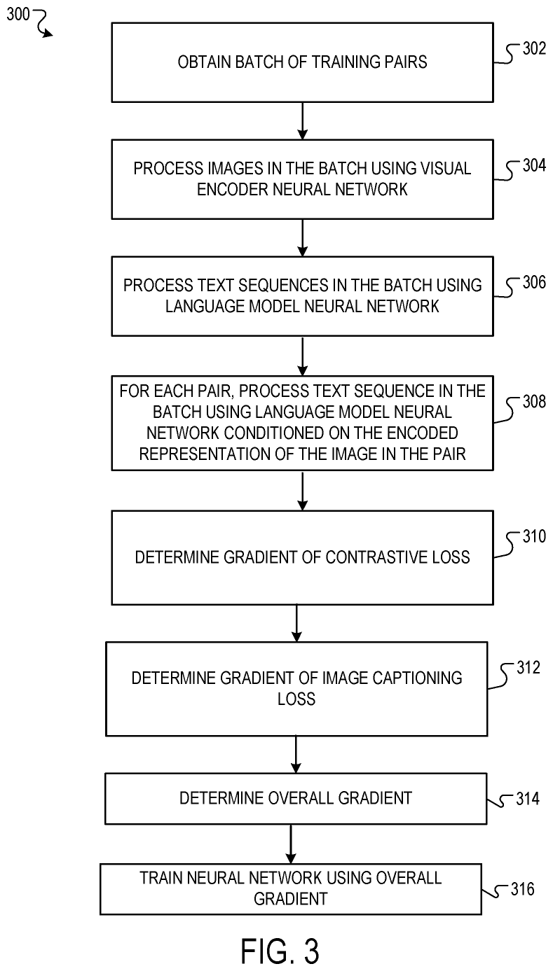

One example of performing the training process is described below with reference to FIG. 3.

Generally, as described above, the decoder-only language model neural network includes (i) one or more self-attention layers and (ii) one or more cross-attention layers. Thus, making use of the cross-attention layers introduces a dependency on the input image in the representations of the input text sequence that are generated by the language model neural network.

To account for this, the contrastive loss measures similarities between image embeddings generated from encoded representations generated by the visual encoder neural network and text embeddings generated from outputs of the language model neural network with the one or more cross-attention layers disabled. This ensures that the text embeddings that are used for the contrastive loss are independent of the input image.

Moreover, auto-regressive, causal masking may be appropriate for the image captioning loss, but can reduce the quality of the representations generated for use in the contrastive loss.

To account for this, the contrastive loss can measure similarities between image embeddings generated from encoded representations generated by the visual encoder neural network and text embeddings generated from outputs of the language model neural network with the one or more cross-attention layers disabled and the self-attention mechanism applied with a bi-directional mask.

On the other hand, the image captioning loss can measure the quality of text captions generated by the language model neural network with the cross-attention layers enabled and the self-attention mechanism applied with a causal masking given encoded representations generated by the visual encoder neural network.

Modifying the operations performed during a training iteration so that the two losses are evaluated using the appropriate quantities is described below with reference to FIG. 3.

FIG. 3 is a flow diagram of an example process 300 for performing a training iteration during the training of the multi-modal neural network. For convenience, the process 300 will be described as being performed by a system of one or more computers located in one or more locations. For example, a neural network system, e.g., the neural network system 100 of FIG. 1, appropriately programmed, can perform the process 300.

The system obtains a batch of one or more training pairs (step 302).

The system processes each image in the batch using the visual encoder neural network to generate an encoded representation of the image and generates an embedding of the image from the encoded representation (step 304).

The system can generate the image embedding of the image in any of a variety of ways.

For example, the system can generate the image embedding by processing the encoded representation using one or more learned operations that are learned jointly with the training of the neural network.

For example, the system can process the encoded representation using a linear layer and pool the output of the linear layer, e.g., along the spatial dimension, to generate the image embedding. As another example, the system can pool the encoded representation, e.g., along the spatial dimension, to generate an initial embedding and apply a linear layer to the initial embedding to generate the image embedding.

The system processes each text sequence in the batch using the language model neural network with the cross-attention layers disabled to generate an embedding of the text sequence (step 306). That is, the system performs step 306 to generate an embedding of the text sequence that is independent of any of the images in the batch by disabling, i.e., bypassing, the cross-attention layers so that the cross-attention layers are not used during the processing of the text sequence. Optionally, the system can also configure the masking of the self-attention layers to be a bi-directional mask.

The system can generate the text embedding of the text sequence in any of a variety of ways.

As one example, the system can apply global pooling over the sequence dimension of the updated representations generated by the last decoder layer in the sequence that precedes the output subnetwork.

Thus, in this example, only the output subnetwork is not shared between the contrastive and captioning losses, maximizing parameter sharing and improving the quality of the training.

For each pair, the system processes the text sequence in the pair using the language model neural network conditioned on the image in the batch and with a causal mask on the self-attention layers to generate a respective score for each of the tokens in the text sequence (step 308). In particular, the system can ensure that the language model neural network is conditioned on the image by processing the text sequence in the pair using the language model neural network with the cross-attention layers enabled and receiving an input derived from the encoded representation of the image in the pair.

Thus, the system performs two forward passes through the language model neural network as part of performing the process 300, one, independent of the training images, to generate the embedding of the text sequence and one, conditioned on the corresponding training image, to generate the respective scores for the tokens in the text sequence.

The system determines a gradient of the contrastive loss as computed using the embeddings of the images in the batch and the embeddings of the text sequences in the batch (step 310).

The goal of the contrastive loss is to train the visual encoder and the language model so that they can embed image and text inputs into the representation space, i.e., the space of the image and text embeddings, in such a way that inputs with similar semantics are mapped to nearby points regardless of their modalities.

Thus, the system can train the neural network 112 and the neural network 120 on a contrastive loss that encourages, for all training pairs in the batch that include a visual input xᵢ and a text sequence yᵢ, the text embedding of xᵢ and the image embedding of yᵢ to be closer together while being farther from all other embeddings of all other visual inputs and text segments in the batch.

A particular example of a contrastive loss will be described next.

Based on the embeddings for the images and the text segments in the pairs in the mini-batch, an N×N similarity matrix A is computed, where A_{i;j} is a value that represents how similar the embedding of xᵢ is to the embedding of yⱼ. For example, A_{i;j} can be the dot product between the embedding of xᵢ and the embedding of yⱼ.

The system can then train the language model neural network and the visual encoder neural network using gradients of a contrastive loss computed using the matrix A. For example, the contrastive loss can be the cross-entropy loss on the rows and columns of A, where the diagonal entries are treated as correct classes while other entries are treated as incorrect classes. A specific example of such a loss is:

$${L}_{Con} = - \frac{1}{N} ( {\sum }_{i = 1}^{N} log ( \frac{{e}^{\frac{{A}_{i , i}}{σ}}}{{\sum }_{j} {e}^{\frac{{A}_{i , j}}{σ}}} ) + {\sum }_{j = 1}^{N} log ( \frac{{e}^{\frac{{A}_{j , j}}{σ}}}{{\sum }_{i} {e}^{\frac{{A}_{i , j}}{σ}}} ) ) ,$$

where σ is the softmax temperature that scales the logits, e.g., which serves to steepen or dampen the softmax distributions in the rows and columns of A, and N is the total number of training pairs in the batch. In some cases, prior to computing the matrix A, the system normalizes the contrastive representations and the uni-modal representations of the visual inputs and text sequences in the batch.

As this loss is minimized, for all pairs in the batch, the embeddings of xᵢ and yᵢ become closer together while becoming farther from all other embeddings of all other visual inputs and text segments in the batch, thereby achieving the goal of the contrastive learning.

As another example, the system can instead use a focal contrastive loss.

The focal contrastive loss can be expressed as:

$${L}_{focal} = - \frac{1}{N} ( {\sum }_{i = 1}^{N} {\sum }_{j = 1}^{N} {( 1 - {p}_{i} )}^{γ} log ( {p}_{i} ) ) ,$$

$$where {p}_{i} = \{ \begin{matrix}σ ( \frac{{v}_{i} {l}_{j}}{τ} ) if i = j \\ 1 - σ ( \frac{{v}_{i} {l}_{j}}{τ} ) if i \neq j\end{matrix} ,$$

where vᵢ is a normalized version of the image embedding for the image in i-th pair in the batch and lⱼ is a normalized version of the text embedding for the text sequence in the j-th pair in the batch.

Alternatively, the focal contrastive loss can be expressed as the sum of a text to image focal loss and an image to text focal loss, as follows:

$${L}_{focal} = - \frac{1}{N} ( {\sum }_{i = 1}^{N} {\sum }_{j = 1}^{N} {( 1 - {p}_{i} )}^{γ} log ( {p}_{i} ) ) - \frac{1}{N} ( {\sum }_{j = 1}^{N} {\sum }_{i = 1}^{N} {( 1 - {p}_{i} )}^{γ} log ( {p}_{i} ) ) ,$$

$$where {p}_{i} = \{ \begin{matrix}σ ( \frac{{v}_{i} {l}_{j}}{τ} ) if i = j \\ 1 - σ ( \frac{{v}_{i} {l}_{j}}{τ} ) if i \neq j\end{matrix}$$

The system determines a gradient of the image captioning loss as computed using, for each pair, the respective scores for each of the tokens in the text sequence (step 312).

As described above, the image captioning loss is generally based on, for a given training pair, the scores assigned to the tokens in the training text sequence by the language model neural network (when conditioned on the visual input in the training pair).

As a particular example, the captioning loss for a given training pair may be given by:

$${L}_{Cap} = - {\sum }_{t = 1}^{T} log {P}_{θ} ( {y}_{t} \vert {y}_{< t} , x ) ,$$

with the overall captioning loss being the average of the captioning losses for the training pairs in the batch, T being the total number of positions in the training text sequence in the training pair, and P_{θ}(yₜ|y_{<t}, x) being the score assigned, in the score distribution that was generated conditioned on the tokens preceding the token at position t in the training text sequence and the visual input x in the training pair, to the token yₜ at the position t in the training text sequence.

The system determines an overall gradient of the overall loss function from the gradients of the contrastive loss and the gradients of the image captioning loss (step 314). For example, the overall gradient can be a weighted sum of the contrastive loss and the image captioning loss.

The system trains the multi-modal neural network using the overall gradient (step 316). For example, the system can apply an optimizer to the overall gradient and the current values of the network parameters of the multi-modal neural network to update the current values of the network parameters.

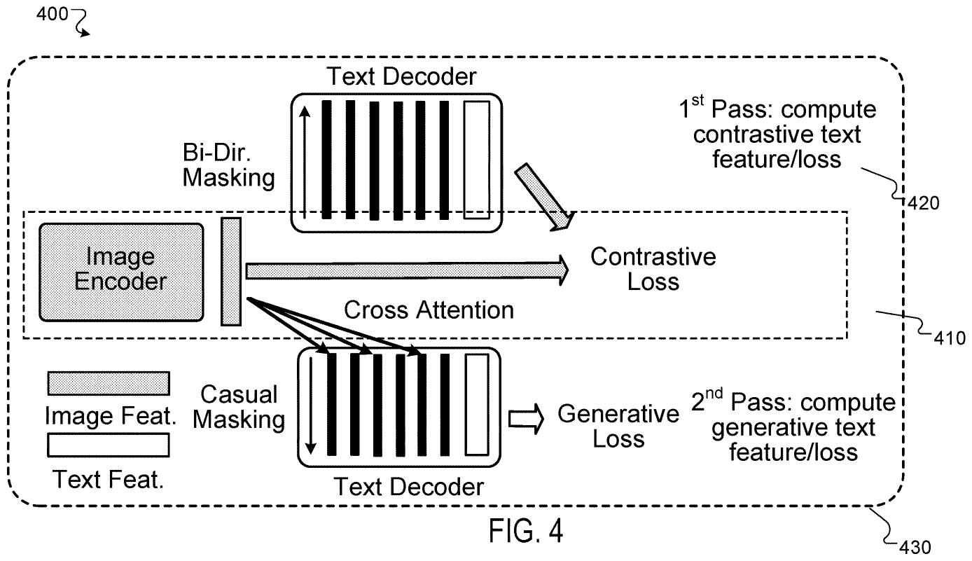

FIG. 4 shows an example 400 of performing a training iteration.

As shown in the example 400, the system performs three forward passes during a given training iteration.

In particular, the system performs a forward pass 410 through the visual input encoder neural network to generate, for each image in the batch, the encoded representation of the image and the image embedding of the image.

The system performs a first forward pass 420 through the language model neural network without using cross-attention and with bi-direction asking on the self-attention layers to generate the text embeddings of each of the text sequences. As can be seen from the example 400, the text embeddings are computed independent of any of the images in the batch.

The system can then use the text and image embeddings to evaluate the contrastive loss as described above.

The system also performs a second forward pass 430 through the language model neural network with cross-attention enabled and with causal masking to generate the scores necessary to compute the image captioning (“generative”) loss. Because of the use of cross-attention, the generative loss features are conditioned on the corresponding input image.

In some implementations, the system trains the visual input encoder on training data that includes image—text pairs, while the downstream task requires processing videos. In these implementations, the system can process embeddings of image patches using the visual input encoder during training and process embeddings of “video tubes” that each represent a spatio-temporal patch that covers a corresponding spatial region within multiple video frames during downstream fine-tuning and when performing the downstream task. The system can extract the video tubes and project the video tubes to embeddings using learned components that are learned as part of the downstream training.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:

Clause 1. A method of training a neural network for performing one or more multi-modal tasks, the neural network comprising:
a visual encoder neural network that is configured to process a visual input that includes one or more images to generate an encoded representation of the visual input; and
a decoder-only language model neural network, wherein the decoder-only language model neural network is configured to process a current text sequence to generate an output defining a new token to be appended to the current text sequence, wherein the current text sequence comprises a respective text token at each of one or more input positions, and wherein the training comprises:
obtaining a training data set, the training data set comprising a plurality of image—text sequence pairs; and
training the neural network on the training data set to minimize an overall loss function that comprises (i) a contrastive loss that measures similarities between image embeddings generated from encoded representations generated by the visual encoder neural network and text embeddings generated from outputs of the language model neural network and (ii) an image captioning loss that measures a quality of text captions generated by the language model neural network given encoded representations generated by the visual encoder neural network.

Clause 2. The method of clause 1, further comprising:
after training the neural network, using the neural network to perform a downstream multi-modal task.

Clause 3. The method of clause 2, wherein using the neural network to perform a downstream multi-modal task comprises:
training a downstream neural network that comprises the visual encoder and the language model neural network on training data for the downstream multi-modal task.

Clause 4. The method of clause 3, wherein using the neural network to perform the downstream multi-modal task comprises:
processing task inputs for the downstream multi-modal task using the trained downstream neural network to generate task outputs for the downstream multi-modal task.

Clause 5. The method of clause 2, wherein using the neural network to perform a downstream multi-modal task comprises processing task inputs for the downstream multi-modal task using the trained neural network to generate task outputs for the downstream multi-modal task.

Clause 6. The method of clause 5, wherein using the neural network to perform a downstream multi-modal task comprises using the neural network to perform the downstream multi-modal task without fine-tuning the trained neural network.

Clause 7. The method of any preceding clause, wherein the language model neural network comprises a sequence of layers, wherein each layer in the sequence receives as input a respective current representation of each of the text tokens in the current text sequence and generates as output a respective updated representation of each of the text tokens in the current text sequence, and wherein the sequence of layers comprises:
one or more self-attention layers, each self-attention attention layer configured to receive as input a respective current representation of each of the text tokens in the current text sequence and to process the respective current representations to generate as output a respective updated representation of each of the text tokens in the current text sequence by applying a self-attention mechanism over the respective current representations of each of the text tokens in the current text sequence; and
one or more cross-attention layers, each cross-attention layer configured to apply a cross-attention mechanism between an input derived from the encoded representation of the visual input and the respective current representations of the text tokens in the current text sequence received as input by the cross-attention layer.

Clause 8. The method of clause 7, wherein the contrastive loss measures similarities between image embeddings generated from encoded representations generated by the visual encoder neural network and text embeddings generated from outputs of the language model neural network with the one or more cross-attention layers disabled.

Clause 9. The method of clause 8, wherein the contrastive loss measures similarities between image embeddings generated from encoded representations generated by the visual encoder neural network and text embeddings generated from outputs of the language model neural network with the one or more cross-attention layers disabled and the self-attention mechanism applied with a bi-directional mask.

Clause 10. The method of clause 8 or clause 9, wherein the image captioning loss measures a quality of text captions generated by the language model neural network with the cross-attention layers enabled and the self-attention mechanism applied with a causal masking given encoded representations generated by the visual encoder neural network.

Clause 11. The method of any one of clauses 7-10, wherein each text embedding is generated from the updated representations generated by the last layer in the sequence.

Clause 12. The method of any one of clauses 7-11, wherein training the neural network comprises:
obtaining a batch of a plurality of image-text sequence pairs;
processing each image in the batch using the visual encoder neural network to generate an encoded representation of the image and generating an embedding of the image from the encoded representation;
processing each text sequence in the batch using the language model neural network with the cross-attention layers disabled to generate an embedding of the image;
for each pair, processing the text sequence in the pair using the language model neural network with the cross-attention layers enabled and receiving an input derived from the encoded representation of the image in the pair and with a causal mask on the self-attention mechanism to generate a respective score for each of the tokens in the text sequence;
determining a gradient of the contrastive loss as computed using the embeddings of the images in the batch and the embeddings of the text sequences in the batch;
determining a gradient of the image captioning loss as computed using, for each pair, the respective scores for each of the tokens in the text sequence;
determining an overall gradient of the overall loss function from the gradients of the contrastive loss and the gradients of the image captioning loss; and
training the neural network using the overall gradient.

Clause 13. The method of any one of clauses 7-10, wherein processing each text sequence in the batch using the language model neural network with the cross-attention layers disabled to generate an embedding of the image comprises: processing each text sequence in the batch using the language model neural network with the cross-attention layers disabled and with a bi-directional mask on the self-attention mechanism to generate an embedding of the image.

Clause 14. The method of any one of clauses 7-13, wherein
the respective current representations that are received as input by a first layer in the sequence are respective embeddings of each of the text tokens in the current text sequence, and
the respective current representations that are received as input by each layer after the attention layer in the sequence are respective updated representations of the text tokens in the current text sequence that are generated as output by a preceding layer in the sequence.

Clause 15. The system of any preceding clause, wherein the output defining the new token to be appended to the current text sequence comprises a score distribution that assigns a respective score to each text token in a vocabulary of text tokens.

Clause 16. The method of clause 15, when dependent on clause 15, wherein the language model neural network comprises a vocabulary embedding layer configured to map an output of the last layer in the sequence to the score distribution.

Clause 17. The method of any preceding clause, wherein the encoded representation comprises a respective updated token for each of a plurality of patches of the visual input.

Clause 18. The method of any preceding clause wherein the visual encoder neural network is a vision Transformer neural network.

Clause 19. The method of any preceding clause, wherein each image embedding is generated by processing a corresponding encoded representation using one or more learned operations that are learned jointly with the training of the neural network.

Clause 20. The method of clause 20, wherein generating each image embedding comprises:
processing the corresponding encoded representation using a linear layer and pooling an output of the linear layer; or
pooling the encoded representation to generate an initial embedding and applying a linear layer to the initial embedding to generate the image embedding.

Clause 21. The method of any preceding clause, wherein the contrastive loss is a focal contrastive loss.

Clause 22. The method of any preceding clause when dependent on clause 18, wherein the vision Transformer neural network uses cropped positional embeddings.

Clause 23. A system comprising:
one or more computers; and
one or more storage devices storing instructions that, when executed by the one or more computers, cause the one or more computers to perform the respective operations of the method of any one of clauses 1-22.

Clause 24. One or more computer-readable storage media storing instructions that when executed by one or more computers cause the one or more computers to perform the respective operations of the method of any one of clauses 1-22.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of training a neural network for performing one or more multi-modal tasks, the neural network comprising:
a visual encoder neural network that is configured to process a visual input that includes one or more images to generate an encoded representation of the visual input; and
a decoder-only language model neural network, wherein the decoder-only language model neural network is configured to process a current text sequence to generate an output defining a new token to be appended to the current text sequence, wherein the current text sequence comprises a respective text token at each of one or more input positions, and wherein the training comprises:
obtaining a training data set, the training data set comprising a plurality of image-text sequence pairs; and
training the neural network on the training data set to minimize an overall loss function that comprises (i) a contrastive loss that measures similarities between image embeddings generated from encoded representations generated by the visual encoder neural network and text embeddings generated from outputs of the language model neural network and (ii) an image captioning loss that measures a quality of text captions generated by the language model neural network given encoded representations generated by the visual encoder neural network.

2. The method of claim 1, further comprising:
after training the neural network, using the neural network to perform a downstream multi-modal task.

3. The method of claim 2, wherein using the neural network to perform a downstream multi-modal task comprises:
training a downstream neural network that comprises the visual encoder and the language model neural network on training data for the downstream multi-modal task.

4. The method of claim 3, wherein using the neural network to perform the downstream multi-modal task comprises:
processing task inputs for the downstream multi-modal task using the trained downstream neural network to generate task outputs for the downstream multi-modal task.

5. The method of claim 2, wherein using the neural network to perform a downstream multi-modal task comprises processing task inputs for the downstream multi-modal task using the trained neural network to generate task outputs for the downstream multi-modal task.

6. The method of claim 5, wherein using the neural network to perform a downstream multi-modal task comprises using the neural network to perform the downstream multi-modal task without fine-tuning the trained neural network.

7. The method of claim 1, wherein the language model neural network comprises a sequence of layers, wherein each layer in the sequence receives as input a respective current representation of each of the text tokens in the current text sequence and generates as output a respective updated representation of each of the text tokens in the current text sequence, and wherein the sequence of layers comprises:
one or more self-attention layers, each self-attention attention layer configured to receive as input a respective current representation of each of the text tokens in the current text sequence and to process the respective current representations to generate as output a respective updated representation of each of the text tokens in the current text sequence by applying a self-attention mechanism over the respective current representations of each of the text tokens in the current text sequence; and
one or more cross-attention layers, each cross-attention layer configured to apply a cross-attention mechanism between an input derived from the encoded representation of the visual input and the respective current representations of the text tokens in the current text sequence received as input by the cross-attention layer.

8. The method of claim 7, wherein the contrastive loss measures similarities between image embeddings generated from encoded representations generated by the visual encoder neural network and text embeddings generated from outputs of the language model neural network with the one or more cross-attention layers in the language model neural network disabled.

9. The method of claim 8, wherein the contrastive loss measures similarities between image embeddings generated from encoded representations generated by the visual encoder neural network and text embeddings generated from outputs of the language model neural network with the one or more cross-attention layers in the language model neural network disabled and the self-attention mechanism applied with a bi-directional mask.

10. The method of claim 8, wherein the image captioning loss measures a quality of text captions generated by the language model neural network with the cross-attention layers enabled and the self-attention mechanism applied with a causal masking given encoded representations generated by the visual encoder neural network.

11. The method of claim 7, wherein each text embedding is generated from the updated representations generated by the last layer in the sequence.

12. The method of claim 7, wherein training the neural network comprises:
obtaining a batch of a plurality of image-text sequence pairs;
processing each image in the batch using the visual encoder neural network to generate an encoded representation of the image and generating an embedding of the image from the encoded representation;
processing each text sequence in the batch using the language model neural network with the cross-attention layers disabled to generate an embedding of the text sequence;
for each pair, processing the text sequence in the pair using the language model neural network with the cross-attention layers enabled and receiving an input derived from the encoded representation of the image in the pair and with a causal mask on the self-attention mechanism to generate a respective score for each of the tokens in the text sequence;
determining a gradient of the contrastive loss as computed using the embeddings of the images in the batch and the embeddings of the text sequences in the batch;
determining a gradient of the image captioning loss as computed using, for each pair, the respective scores for each of the tokens in the text sequence;
determining an overall gradient of the overall loss function from the gradients of the contrastive loss and the gradients of the image captioning loss; and
training the neural network using the overall gradient.

13. The method of claim 7, wherein processing each text sequence in the batch using the language model neural network with the cross-attention layers disabled to generate an embedding of the image comprises:
processing each text sequence in the batch using the language model neural network with the cross-attention layers disabled and with a bi-directional mask on the self-attention mechanism to generate an embedding of the image.

14. The method of claim 7, wherein
the respective current representations that are received as input by a first layer in the sequence are respective embeddings of each of the text tokens in the current text sequence, and
the respective current representations that are received as input by each layer after the attention layer in the sequence are respective updated representations of the text tokens in the current text sequence that are generated as output by a preceding layer in the sequence.

15. The method of claim 1, wherein the output defining the new token to be appended to the current text sequence comprises a score distribution that assigns a respective score to each text token in a vocabulary of text tokens.

16. The method of claim 15, wherein the language model neural network comprises a vocabulary embedding layer configured to map an output of the last layer in the sequence to the score distribution.

17. The method of claim 1, wherein the encoded representation comprises a respective updated token for each of a plurality of patches of the visual input.

18. The method of claim 1 wherein the visual encoder neural network is a vision Transformer neural network.

19. The method of claim 1, wherein each image embedding is generated by processing a corresponding encoded representation using one or more learned operations that are learned jointly with the training of the neural network.

20. The method of claim 20, wherein generating each image embedding comprises:
processing the corresponding encoded representation using a linear layer and pooling an output of the linear layer; or
pooling the encoded representation to generate an initial embedding and applying a linear layer to the initial embedding to generate the image embedding.

21. The method of claim 1, wherein the contrastive loss is a focal contrastive loss.

22. The method of claim 18, wherein the vision Transformer neural network uses cropped positional embeddings.

23. A system comprising:
one or more computers; and
one or more storage devices storing instructions that, when executed by the one or more computers, cause the one or more computers to perform operations for training a neural network for performing one or more multi-modal tasks, the neural network comprising:
a visual encoder neural network that is configured to process a visual input that includes one or more images to generate an encoded representation of the visual input; and
a decoder-only language model neural network, wherein the decoder-only language model neural network is configured to process a current text sequence to generate an output defining a new token to be appended to the current text sequence, wherein the current text sequence comprises a respective text token at each of one or more input positions, and wherein the training comprises:
obtaining a training data set, the training data set comprising a plurality of image-text sequence pairs; and
training the neural network on the training data set to minimize an overall loss function that comprises (i) a contrastive loss that measures similarities between image embeddings generated from encoded representations generated by the visual encoder neural network and text embeddings generated from outputs of the language model neural network and (ii) an image captioning loss that measures a quality of text captions generated by the language model neural network given encoded representations generated by the visual encoder neural network.

24. One or more computer-readable storage media storing instructions that when executed by one or more computers cause the one or more computers to perform operations for training a neural network for performing one or more multi-modal tasks, the neural network comprising:
a visual encoder neural network that is configured to process a visual input that includes one or more images to generate an encoded representation of the visual input; and
a decoder-only language model neural network, wherein the decoder-only language model neural network is configured to process a current text sequence to generate an output defining a new token to be appended to the current text sequence, wherein the current text sequence comprises a respective text token at each of one or more input positions, and wherein the training comprises:
obtaining a training data set, the training data set comprising a plurality of image-text sequence pairs; and
training the neural network on the training data set to minimize an overall loss function that comprises (i) a contrastive loss that measures similarities between image embeddings generated from encoded representations generated by the visual encoder neural network and text embeddings generated from outputs of the language model neural network and (ii) an image captioning loss that measures a quality of text captions generated by the language model neural network given encoded representations generated by the visual encoder neural network.
